(19) United States
(12) Patent Application Publication
(10) Pub. No.: US 2025/0250981 A1
(43) Pub. Date: Aug. 7, 2025

(54) M12 Plug-in for Threaded Cable Connection

(71) Applicant: KSB SE & Co. KGaA, Frankenthal (DE)

(72) Inventor: Andreas WOLF, Frankenthal (DE)

(21) Appl. No.: 18/836,890

(22) PCT Filed: Jan. 13, 2023
(86) PCT No.: PCT/EP2023/050680

§ 371 Date: Mar. 27, 2025

(30) Foreign Application Priority Data
Feb. 9, 2022 (DE) 10 2022 103 001.6

(51) Int. Cl. F04D 13/06; H01R 13/52; H01R 13/622

(52) U.S. Cl. CPC F04D 13/0693; H01R 13/5219; H01R 13/622; H01R 2201/10

(57) ABSTRACT

The invention relates to a centrifugal pump comprising a module (2). The module (2) comprises at least one cable connection assembly (3) with at least one threaded connection (5). An M12 jack is integrated into the threaded connection (5).

### CROSS REFERENCE TO RELATED APPLICATION

This application claims priority under 35 U.S.C. § 119 from German Patent Application No. 102022103001.6, filed Feb. 9, 2022, the entire disclosure of which is herein expressly incorporated by reference.

### BACKGROUND AND SUMMARY

The disclosure relates to a centrifugal pump with a module which comprises a cable connection assembly with at least one threaded connection.

The speed of a centrifugal pump and accordingly the torque of the impeller shaft as well as the flow rate of the centrifugal pump are usually controlled in an open or closed loop with a module for open- or closed-loop control in an electronics casing. Such a module for driving a centrifugal pump can be located close to the electric motor and comprises, for example, a frequency inverter and a speed closed-loop control device. Such a module can furthermore comprise additional open-loop or closed-loop control devices. In addition, the electronics casing of the module requires, for example, inputs for signals from sensors and outputs for corrective signals. The signals are usually transmitted by means of cables which are often inserted into such a module with the aid of threaded cable connections.

A threaded cable connection or a threaded connection is a cable inlet functioning as a compression gland which affords particularly good sealing of a cable, a line, or an insulated conductor when it passes through a casing wall.

A module comprises at least one cable connection assembly for connecting the cable for the input and output signals. In order to connect a cable, a bushing in an existing threaded connection is generally activated and the cable ends are connected manually to the cable connection assembly. Alternatively, a bore can be introduced into the electronics casing and the cable for the signals inserted through the borehole. Disadvantages of this procedure are the very complex assembly and the problem of ensuring a sufficient seal against the penetration of dirt and water.

An M12 plug connector is a round threaded plug connector with a metric locking thread and is in practice a standard for the connection of sensors, and recently also of bus lines. The male variant of the round plug connector for the connection of signal-carrying cables is referred to as an M12 plug and the female form as an M12 socket.

If there is no connection option for connecting such a standardized connector, the electronics casing of a module for driving a centrifugal pump has to be expanded by an M12 socket. This too entails very complex assembly in combination with the already explained sealing problem.

One object of the disclosure is to provide a centrifugal pump with a module which enables quick and safe connection for standardized signal routing. It is intended here that the connection of a signal-carrying line can be configured as simply as possible and can be implemented cost-effectively. It is furthermore intended that the connection of a signal-carrying line affords as much protection as possible from the penetration of dirt and liquids.

This object is achieved according to the disclosure by a centrifugal pump with a module. Preferred variants can be found in the subordinate main claim, the dependent claims, the description, and the drawings.

According to the disclosure, an M12 socket is integrated into a threaded connection of the module.

The integration of an M12 socket into an M20 threaded connection can be configured particularly favorably because the socket can take up exactly the available internal space of the threaded connection. Fixing can be effected for the robust configuration of the connection with the aid of a fixing element.

In a favorable variant of the disclosure, the module has a plurality of threaded connections with an integrated M12 socket. In this way, the module for open- and closed-loop control can provide a sufficient number of required signal inputs and outputs.

Ideally, the M12 socket has a connector to the cable connection assembly of the module. As a result, the connection is ready to use as a so-called plug-in connection and there is no need for subsequent manual assembly and connection tasks. This furthermore also means that the installed electronics are protected from any improper access.

A threaded connection in the form of a threaded cable connection also comprises, in the unconnected state, a seal and a covering in the form of a nut with an internal thread. In a particularly advantageous alternative embodiment, the threaded connection comprises a nut with an internal thread into which an M12 plug is integrated. In order to connect, for example, a new sensor, all that is required is to unscrew the blind nut and to screw in the nut with the integrated M12 plug. This results in very quick and efficient plug-in installation of a new signal-carrying line with minimal effort.

Ideally, an M12 plug fits exceptionally well into an M20 threaded connection (clarify: principle, word choice) without any challenging assembly effort. The fixing of the M12 plug which is inserted into an M20 threaded connection can be assisted by means of a fixing element, for example a set screw.

The threaded connection preferably comprises a sleeve for inserting and supporting, as well as positioning, the signal-carrying line which is connected to the M12 plug. The sleeve here has an elongated shape for insertion into the threaded connection and thus fits exactly in terms of the diameter into the predetermined opening of the threaded connection.

In a particularly favorable variant of the disclosure, the sleeve has a length of more than 50%, preferably more than 60%, in particular more than 70%, of the length of the threaded connection. As a result, the transition region of the flexible cable into the rigid threaded connection is protected and supported over a sufficiently large region.

The threaded connection, designed as a threaded cable connection, ideally has a sealing element which protects the cable inlet and hence the M12 plug connector from the penetration of dirt and liquids.

In a particularly advantageous embodiment of the disclosure, the threaded connection with the integrated M12 plug connector is sealed in accordance with IP68. As a result, the threaded connection and the cable connection are configured as dust-tight and watertight with respect to the M12 plug.

The advantageous embodiment of the M12 plug connector in an M20 threaded connection entails a favorable reduction in the assembly effort. In order to integrate, for example, a new sensor signal sent by cable, the electronics casing of the module no longer has to be opened or even drilled through for the installation. As a result, no further problems arise with the sealing of a bore and cable inlet.

Ideally, the space inside the module can be optimized by the design according to the disclosure of the module, with an M12 plug connector integrated into the threaded connection. By virtue of providing at least one, ideally a plurality of threaded connections with an integrated M12 plug connector, subsequent assembly in the module is no longer necessary, as a result of which the space provided for it can be omitted.

In a particularly advantageous variant of the disclosure, sensors are, for example, connected in the module for the open- or closed-loop control of a centrifugal pump exclusively via M12 plug connectors and no longer via clamping contacts. The module can be improved as a result in terms of the two- and three-dimensional space requirement.

The M12 plug connector advantageously fits perfectly into an M20 threaded connection. It is thus possible to retrofit the M12 plug connectors for modules which are already in operation for driving centrifugal pumps in already existing M20 threaded connections quickly, cost-effectively, and without a large amount of assembly effort. As a result, a sensor can, for example, be efficiently retrofitted to an M12-based plug connector.

The use of such a plug-in plug connector in threaded connections can be implemented cost-effectively even at a low number of units and the M12 plug-in plug connector can be used in many modules, even very different ones, for driving centrifugal pumps.

According to the disclosure, a threaded cable connection is used as an M12 plug-in plug connector for sensors for connection to open-loop or closed-loop control systems of centrifugal pumps.

Further features and advantages of the disclosure can be found in the description of exemplary embodiments on the basis of the drawings, and in the drawings themselves, in which:

### BRIEF DESCRIPTION OF THE DRAWINGS

FIG. 1 shows a perspective view of an electric motor with a module; and

FIG. 2 shows a side view of an M12 plug.

### DETAILED DESCRIPTION

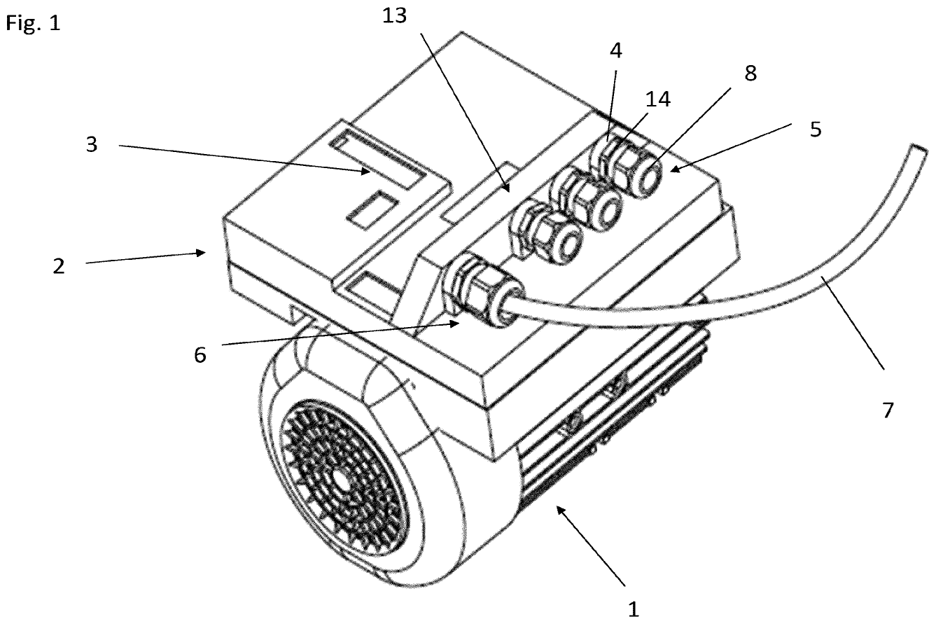

FIG. 1 shows an electric motor 1 with a module 2 which serves to drive a centrifugal pump. The module 2 is arranged on the electric motor 1 and is seated flush with the cooling ribs. A current-carrying cable 7 is, by way of example, connected to the current-carrying threaded connection 6 of the connection block 13.

The module 2 comprises three threaded connections 5 which, together with the current-carrying threaded connection 6, form the connection block 13. A threaded connection 5 consists of a stationary sleeve 4 with an external thread and an external hex element 14, as well as a nut 8 with an internal thread. An M12 socket is integrated into each stationary sleeve 4 with an external thread and is positioned with a fixing element. The M12 sockets each have a connector to the cable connection assembly 3 in which the signals are further processed in open-loop or closed-loop control components.

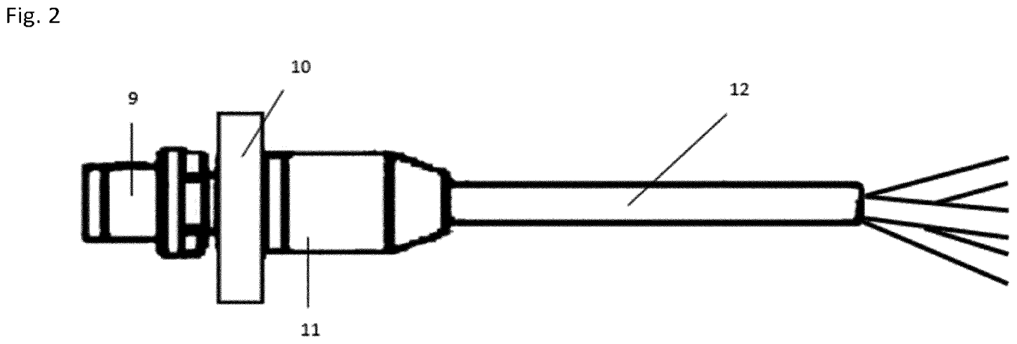

A side view of an M12 plug is illustrated in FIG. 2. A sealing element 10 which adjoins the specially shaped sleeve 11 is arranged behind the M12 plug 9. The cable 12 is inserted into the M12 plug, supported protectively, and also held with the aid of the sleeve 11. The sleeve 12 here has an elongated shape and has a particularly flexible design. The sleeve 12 has a length of 60% of the length of the threaded connection. The nut 8 (not illustrated) with an internal thread is pushed over the illustrated M12 plug 9 from the cable side, as a result of which the sealing element 10 forms a seal against dirt and water in accordance with IP68 inside the nut 8 in the direction of the M12 plug 9.

The foregoing disclosure has been set forth merely to illustrate the disclosure and is not intended to be limiting. Since modifications of the disclosed embodiments incorporating the spirit and substance of the disclosure may occur to persons skilled in the art, the disclosure should be construed to include everything within the scope of the appended claims and equivalents thereof.

1.-8. (canceled)

9. A centrifugal pump comprising:
a module having a cable connection assembly with a threaded connection; and
an M12 socket, wherein the M12 socket is integrated into the threaded connection.

10. The centrifugal pump as claimed in claim 9, wherein the threaded connection comprises a nut with an internal thread into which an M12 plug is integrated.

11. The centrifugal pump as claimed in claim 10, wherein the threaded connection has a sealing element.

12. The centrifugal pump as claimed in claim 11, wherein the threaded connection includes a sleeve in which a cable is connected to the M12 plug.

13. The centrifugal pump as claimed in claim 12, wherein the sleeve has a length of more than 50 of a length of the threaded connection.

14. The centrifugal pump as claimed in one claim 13, wherein the M12 socket has a connector to the cable-connection assembly.

15. The centrifugal pump as claimed in claim 14, wherein the threaded connection is sealed in accordance with IP68.

16. A method comprising:
using the threaded connection as claimed in claim 15 as an M12 plug-in plug connector for sensors for connection to open-loop or closed-loop control systems of centrifugal pumps.
